(19) United States
(12) Patent Application Publication
(10) Pub. No.: US 2008/0168906 A1
(43) Pub. Date: Jul. 17, 2008

(54) Brewing and extracting apparatus

(75) Inventors: Chih Jung Pan, Taipei (TW); Kuan Wei Lee, Taipei (TW); Shih Hua Chang, Taipei (TW); Shih Hung Cheng, Taipei (TW); Shih Yao Liu, Taipei (TW)

Correspondence Address: BACON & THOMAS, PLLC, 625 SLATERS LANE, FOURTH FLOOR, ALEXANDRIA, VA, 22314, US

(73) Assignee: TSANN KUEN ENTERPRISE CO., LTD., Taipei (TW)

(21) Appl. No.: 12/007,619

(22) Filed: Jan. 14, 2008

(30) Foreign Application Priority Data
Jan. 17, 2007 (TW) 096101811

(51) Int. Cl. A47J 31/10

(52) U.S. Cl. 99/287

(57) ABSTRACT

A brewing and extracting apparatus comprises an extracting cup, an eccentric filter and a stirrer configured inside the extracting cup, wherein the stirrer is driven by a motor so as to generate whirlpool currents from soaking liquid injected into the extracting cup by rotating the stirrer. The eccentric filter has a container placed within the extracting cup and soaked in the soaking liquid wherein the container is on a position deviating from the center of the whirlpool currents so as to bring contents of tea-leaves in the container up increasingly and dissolve the contents into liquid through the whirlpool currents.

### TECHNICAL FIELD

The present invention relates to a brewing and extracting apparatus for the use of brewing extractable subjects with soluble contents, such as tea-leaves, and particularly to a brewing and extracting apparatus applying to a tea-brewing device for increasing the extracting rate of infusing the tea-leaves.

### BACKGROUND ART

Compared with conventional tea-brewing means used by manual control, a tea-brewing device is more convenient and capable of infusing tea-leaves automatically. The method for infusing tea-leaves used by the tea-brewing device is mainly implemented by pouring hot water into a filter storing the tea-leaves so as to extract soluble contents of the tea-leaves from the tea-leaves and dissolve soluble contents into hot water to make tea. However, since tea came from rinsing the surface of tea-leaves directly could not extract soluble contents of the tea-leaves completely and release curling tea-leaves at the same time, tea came from rinsing the surface of the tea-leaves must be laid down for some while to unfold tea-leaves infused in tea slowly and completely and soluble contents of tea-leaves are released into tea by degrees.

Therefore, by the means of brewing tea-leaves through the tea-brewing device, tea with full soluble contents of tea-leaves must be conducted after a period that tea-leaves are soaked.

### SUMMARY OF THE INVENTION

The present invention mainly provides a brewing and extracting apparatus applying to a tea-brewing device so as to make a user enjoy high quality tea fast by increasing efficiencies for dissolving contents of tea-leaves into tea faster and reducing waiting time for soaking tea-leaves in hot water.

To implement above-mentioned purpose, the present invention provides a brewing and extracting apparatus with functions capable of generating whirlpool currents from hot water used for soaking tea-leaves so as to dissolve contents of tea-leaves into tea quickly by the whirlpool currents.

The present invention mainly provides a brewing and extracting apparatus mainly comprising an extracting cup and an eccentric filter having a stirrer inside. The stirrer driven by a motor can be rotated within the extracting cup so as to generate whirlpool currents from soaking liquid poured into the extracting cup. The eccentric filter is a container placed in the extracting cup and soaked in the soaking liquid, wherein the container is in a position deviating from the center of the whirlpool currents so as to extract contents of tea-leaves into infused liquid within the container and dissolve the contents into infused liquid quickly through whirlpool currents.

Therefore, the brewing and extracting apparatus provided by the present invention is applied to a tea-brewing device for increasing the extracting efficiency so as to reduce waiting time for brewing tea.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates an isometric view of a tea-brewing device assembling with a brewing and extracting apparatus according to one embodiment of the present invention.

FIG. 2 illustrates an isometric exploded view of the tea-brewing device disclosed in FIG. 1.

FIG. 3 illustrates a cross-section view of the tea-brewing device assembling with the brewing and extracting apparatus according to one embodiment of the present invention.

FIG. 4 illustrates a bird's view of the brewing and extracting apparatus according to one embodiment of the present invention.

FIG. 5 illustrates a side cross-section view and operation diagram of the brewing and extracting apparatus according to one embodiment of the present invention.

FIG. 6 illustrates a bird's view of the extracting cup of the brewing and extracting apparatus according to one embodiment of the present invention.

### DESCRIPTION OF THE EMBODIMENT

Reference will now be made in detail to the embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

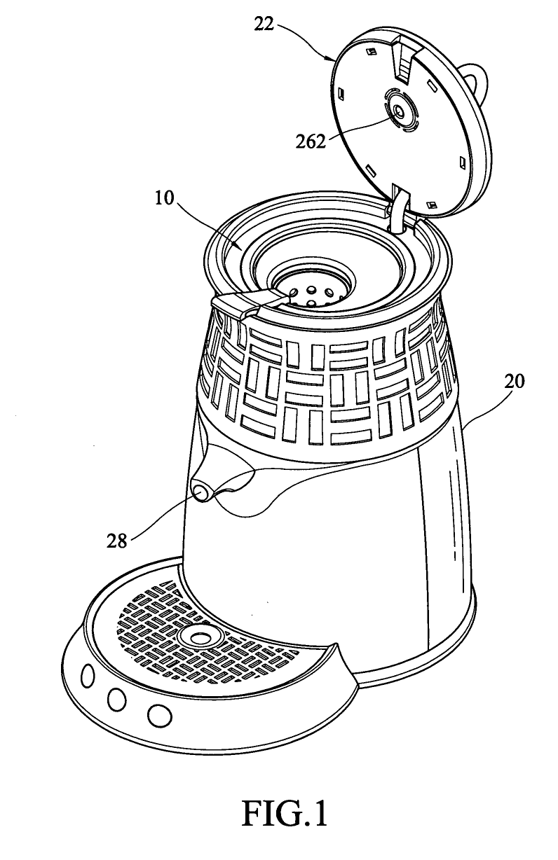

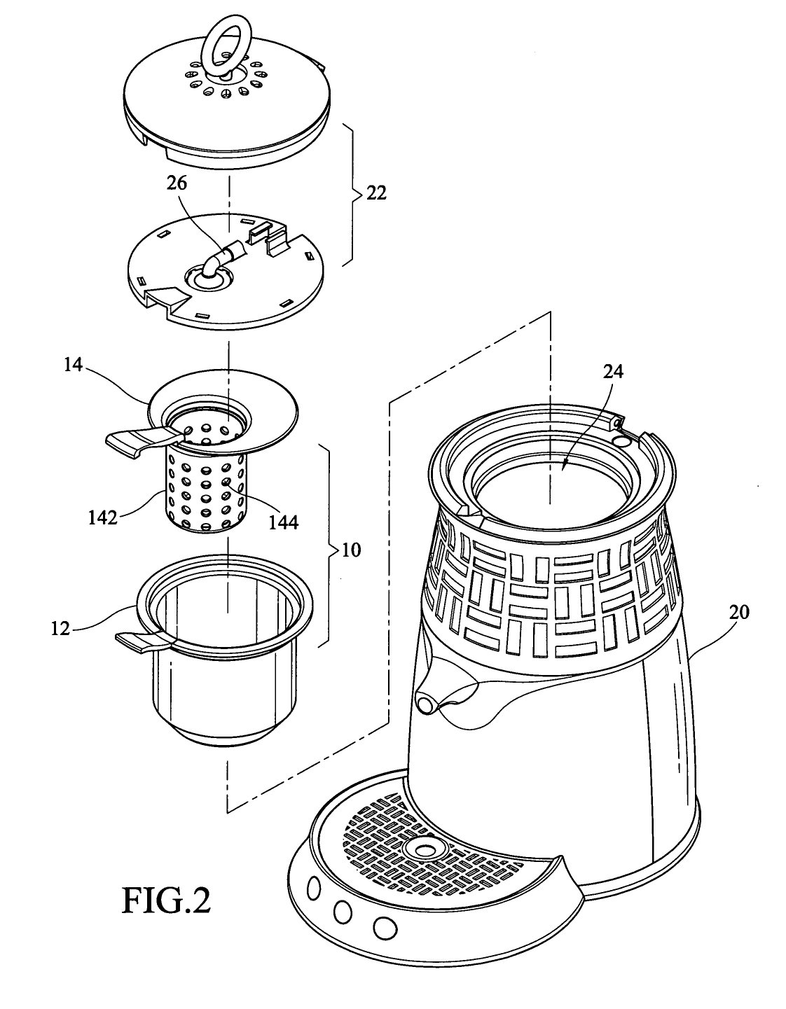

Please referring to FIG. 1, an isometric view of a brewing and extracting apparatus 10 applied to a tea-brewing device 20 according to one embodiment of the present invention is illustrated. Please also referring to FIG. 2, an isometric view of the extracting and brewing apparatus 10 separated from the tea-brewing apparatus 20 is illustrated. The tea-brewing device 20 has a lid 22 which is pivotally connected with one side of the upright of the tea-brewing device so as to open or cover the upright side of the tea-brewing device by revolving. When the lid 22 is opened, a chamber 24 capable of arranging the extracting and brewing device 10 herein is presented on the upright of the tea-brewing device 20.

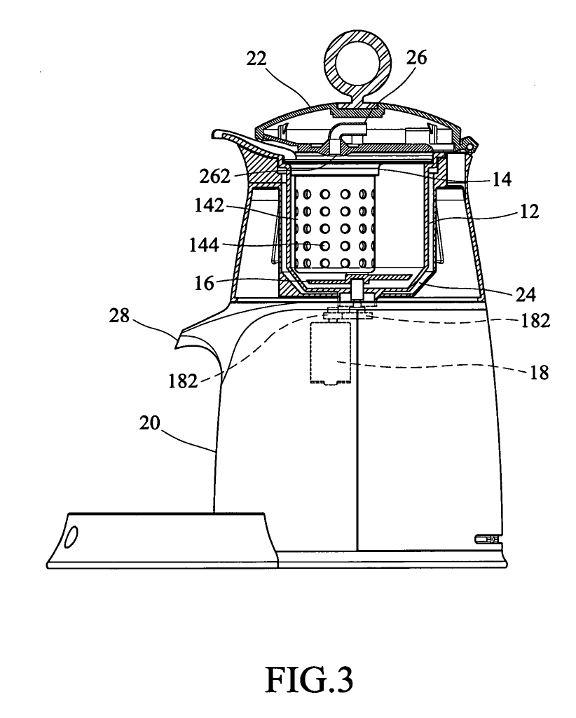

Please referring to FIG.3, a transporting channel 26 is configured inside the lid 22 and a injecting opening 262 capable of injecting soaking liquid into the chamber 24 is configured in the bottom side of the lid 22.

A brewing and extracting apparatus according to the present invention mainly comprises an extracting cup 12 and an eccentric filter 14, wherein a stirrer 16 is configured inside the extracting cup. The stirrer 16 is driven by a motor 18 disposed on the bottom side of the extracting cup 12 so as to provide driving power for operating the stirrer 16. The motor 18 is capable of driving the stirrer 16 by all kinds of transmission mechanism, such as a gear wheel 182 to achieve the purpose of driving the stirrer 16 revolvingly.

The eccentric filter 14 is capable of being superposed on the extracting cup 12, and comprises a container 142 placed into the extracting cup 12. A plurality of filter openings 144 is configured in the edge of the body of the container 142. Shapes and calibers of the filter openings 144 allow soaking liquid to pass through the filter openings 144 but limit tea-leaves within the container 142.

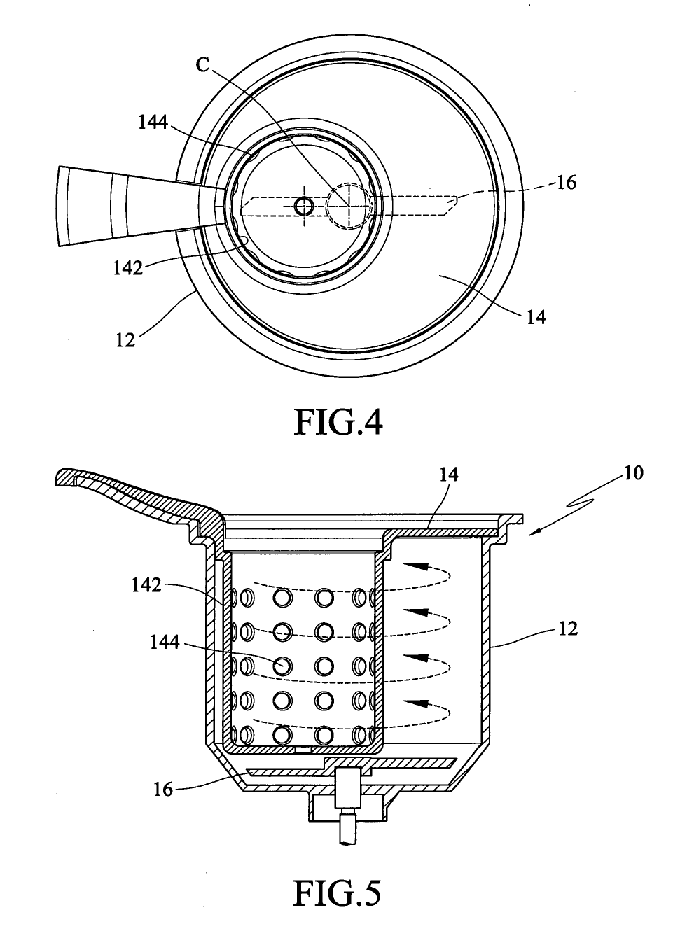

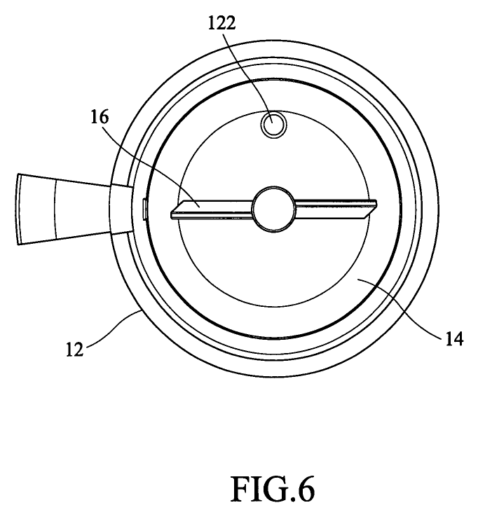

Please referring to FIG. 4, the stirrer 16 is configured on the central position C inside the extracting cup 12. The eccentric filter 14 superposed on the extracting cup 12 includes the container 142 in a position deviating from a center of the extracting cup 12. Therefore, please referring to FIG. 3 and FIG. 5 in the meantime, the extracting cup 12 is configured with the eccentric filter 14 and placed into the chamber 24 of the tea-brewing device 20 with the eccentric filter 14 together after the lid 22 is opened. At the same time, tea-leaves are placed into the container 142 of the eccentric filter 14 and then the lid is closed. After above-mentioned operations are completed, operations for infusing tea-leaves by the tea-brewing device 20 are conducted. When power is turned on, firstly, transporting channel 26 imports hot water or soaking liquid to make soaking liquid directly inject on tea-leaves inside the container 142 through an injecting opening 262 in an opposite position of the container 142 so as to bring contents of tea-leaves up through soaking liquid and dissolve the contents into soaking liquid. At the same time, the motor 18 is enabling to drive the stirrer 16 so as to generate whirlpool currents from soaking liquid which flows into the bottom of the extracting cup 12 from the filter opening 144 (showing as an arrowed direction symbol illustrated in FIG. 5). Since the container 142 is in a position deviating from the center of the whirlpool currents generated by operating the stirrer 16, tea-leaves contained in the container 142 is capable of being infusing by the currents constantly so as to extract the contents from the tea-leaves with better efficiency and dissolve the contents into soaking liquid quickly. Therefore, the brewing and extracting device 10, mainly comprising the eccentric filter 14 and the extracting cup 12 having the stirrer 16, is capable of being assembled within the chamber 24 inside the tea-brewing device 20. When the lid 22 configured on the tea-brewing device 20 is opened, the brewing and extracting device 10 is taken out or replaced in the chamber 24. When above-mentioned brewing operations is completed, tea stored in the extracting cup 12 is drained out via a discharging hole 122 configured in the bottom of the extracting cup 12 so as to make brewing liquid flowing into a storage pre-configured in the tea-brewing device 20 or out of the tea-brewing device 20 via an outlet opening 28 connecting with the discharging hole 122 for drinking. Compared with tea-brewing efficiency of conventional tea-brewing device, since the brewing and extracting apparatus 10 disclosed in accordance with the present invention has the eccentric filter 14 so as to make tea-leaves placed in the container 142 poured by the currents rotating by the stirrer 16. Therefore, the efficiency of brewing tea is increasing.

Foregoing descriptions and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A brewing and extracting apparatus, comprising:
an extracting cup having a stirrer inside the extracting cup for generating whirlpool currents from brewing liquid poured into the extracting cup by operating the stirrer; and
an eccentric filter having a container placed inside the extracting cup for placing tea-leaves in the container and dissolving contents of tea-leaves into brewing liquid,
wherein the container is in a position deviating from a center of the whirlpool currents generated by operating the stirrer so as to accelerating to extract the contents from the tea-leaves and to dissolve the contents into brewing liquid by infusing the tea-leaves with the whirlpool currents.

2. The brewing and extracting apparatus as cited in claim 1, wherein the stirrer is configured within a central position of the extracting cup.

3. The brewing and extracting apparatus as cited in claim 1, wherein the stirrer is combined with a motor for providing driving power.

4. The brewing and extracting apparatus as cited in claim 1, wherein the container has a plurality of filter openings configured in the edge of the body of the container, and the filter openings allow brewing liquid to pass through the container but limit tea-leaves within the container.

5. A brewing and extracting apparatus, assembling into a chamber of a tea-brewing device having a lid for taking the brewing and extracting apparatus out when the lid is opened, comprising:
an extracting cup having a stirrer inside the extracting cup for generating whirlpool currents from brewing liquid poured into the extracting cup by operating the stirrer; and
an eccentric filter having a container placed inside the extracting cup for placing tea-leaves in the container and dissolving contents of tea-leaves into brewing liquid, wherein the container is in a position deviating from a center of the whirlpool currents generated by operating the stirrer so as to accelerating to extract the contents from the tea-leaves and to dissolve the contents into brewing liquid by infusing the tea-leaves with the whirlpool currents.

6. The brewing and extracting apparatus as cited in claim 5, wherein the stirrer is configured within a central position of the extracting cup.

7. The brewing and extracting apparatus as cited in claim 5, wherein a motor is configured in the tea-brewing device for driving the stirrer.

8. The brewing and extracting apparatus as cited in claim 5, wherein the container has a plurality of filter openings configured in the edge of the body of the container, and the filter openings allow brewing liquid to pass through the container but limit tea-leaves within the container.

9. The brewing and extracting apparatus as cited in claim 5, wherein the lid is connected pivotally with the tea-brewing device.

10. The brewing and extracting apparatus as cited in claim 9, wherein a transporting channel is configured inside the lid and a pouring opening capable of pouring brewing liquid into the container is configured in the bottom side of the lid.

11. The brewing and extracting apparatus as cited in claim 10, wherein a discharging hole for discharging the brewing liquid is configured in the extracting cup.

12. The brewing and extracting apparatus as cited in claim 11, wherein the tea-brewing device is further configured with an outlet opening connecting with the discharging hole for making the brewing liquid discharged from the extracting cup and poured out of the tea-brewing device through the outlet opening.
